(19) United States
(12) Patent Application Publication
(10) Pub. No.: US 2009/0242864 A1
(43) Pub. Date: Oct. 1, 2009

(54) RAILINGS

(76) Inventor: John Carney, Cheshire (GB)

Correspondence Address: DANN, DORFMAN, HERRELL & SKILLMAN, 1601 MARKET STREET, SUITE 2400, PHILADELPHIA, PA, 19103-2307, US

(21) Appl. No.: 12/295,978

(22) PCT Filed: Mar. 30, 2007
(86) PCT No.: PCT/GB2007/001174

§ 371 Date: Jan. 22, 2009

(30) Foreign Application Priority Data
Apr. 4, 2006 (GB) 0606812.6

(51) Int. Cl. E04H 17/24; B23P 11/00

(52) U.S. Cl. 256/59; 256/65.05; 29/428

(57) ABSTRACT

A railing mounting component (1) for a modular railing kit/assembly which may including one or more railing lengths (12, 13) of manageable length, the mounting component being arranged to simultaneously mount two adjacent ends (14, 15) of successive lengths of railing by receiving the ends at/in separate dedicated parts (3, 4) of a given mounting component, such that one mounted end cannot obstruct/impede the mounting of the other end, thereby to enable a railing of any overall length to be assembled safely and easily.

The present invention relates to railings, such as handrails, and methods for assembling railings.

Railings as used in domestic, commercial or industrial environments are required to be of any length. Examples include railings of, say, a few metres in length for use as a short domestic handrail e.g. associated with a short flight of stairs, or in a small shop. Other examples include railings, such as handrails, of many metres in length used in a commercial setting such as in a large public area in an apartment/office block, a shopping mall, or a public park e.g. guarding balcony areas or being associated with long flights of steps.

It is necessary to be able to produce railings which are easy to assemble, sturdy and safe when assembled, and versatile in the range of lengths which they can accommodate while remaining smart in appearance.

Currently, lengthy and continuous railing (e.g. handrail) assemblies require the use of one or a few very long railing sections to provide the required structural continuity in the railing and the structural sturdiness and visible appearance of continuity generally deemed desirable in the art. This is expensive both in terms of the cost of producing and handling such lengthy railing sections, and in terms of the time, effort and difficulty of transporting and assembling railings using such components. Indeed, the greater the length of a railing section the greater is its propensity to bend, twist or otherwise deform under its own weight, even when assembled within a railing assembly. This is undesirable as it adds to the stresses imposed upon the assembly and can often appear aesthetically displeasing.

Other problems include the means by which handrail lengths are mounted to mounting locations (e.g. on walls etc). This typically involves the use of screws or nails driven into the surface of a handrail length to fix it to a mounting location or to some intermediate mounting means (e.g. a wall-mounted bracket, or the like). The nails or screws are often not only visible to users of the handrail but are also typically in the line of traverse/sweep of a users hand along the handrail in use. This renders them a potential hazard should nail/screw heads not be suitably sunk—the result being a proud-standing nail/screw head having the potential to cause harm to users. Of course, such nails/screws, in being exposed to the elements, form centres at which rain water may collect and ultimately cause decay or damage to the structure of the hand rail.

The present invention aims to address these difficulties.

At its most general, the invention proposed is a railing mounting component(s) for a modular railing kit/assembly which may include one or more railing lengths (e.g. length(s) of rail) of manageable length, the mounting component(s) being arranged to simultaneously mount two adjacent ends of successive lengths of railing by receiving the ends at/in separate dedicated parts of a given mounting component, such that one mounted end cannot obstruct/impede the mounting of the other end, thereby to enable a railing of any overall length to be assembled safely and easily. The invention need not require nails/screws to be driven into a railing length, or may permit such nails/screws to be concealed in use. The invention may be used for railing assemblies in the form of handrail assemblies, in which the railing lengths are handrail lengths, but other railing applications are envisaged. The invention may provide a kit/assembly including one or more railing lengths. The modular nature of the design enables manageable lengths of railing to be employed, thereby permitting ease of transport when in disassembled (kit) form and ease of assembly. The use of manageable railing lengths also means that twisting, bending or deforming stresses and strains upon a given railing length, due to its own weight, are reduced. Railing lengths, in the present invention, may be in the range of about 0.7 metres to about 1.5 metres, or in the range of about 1 metre to about 1.2 metres. Suitably, the railing lengths may be short enough to fit into (and be transported by) a van or car, such as a family car. The railing length(s) may preferably be substantially rigid, and may be made of wood, metal or another suitable material or substance.

In a first of its aspects, the present invention may provide a kit of parts for a railing (e.g. a handrail) assembly including a first railing (e.g. handrail) length and a mounting means for simultaneously mounting an end of the first railing (e.g. handrail) length and an end of a second railing (e.g. handrail) length to a common mounting location, the mounting means having a first receiving means arranged to receive an end of the first railing length, a second receiving means arranged simultaneously to receive an end of a second railing length, and a partition means positioned (e.g. fixed) between the first and second receiving means and arranged to prevent a railing length from engaging simultaneously parts of both the first receiving means and the second receiving means. In this way, any one end of a railing (e.g. handrail) length may be received by the mounting means without obstructing, impeding or limiting the receipt of the end of another (e.g. the next) railing (e.g. handrail) length. This ensures that each end may be properly, fully and safely received by its dedicated receiving means adding to the structural robustness of the assembly.

The first receiving means may be constructed and arranged to receive one end of the first railing length and the second receiving means may be structured and arranged to receive an end of a second railing length which is substantially identical in dimension, profile, shape or structure to an end (e.g. the other end) of the first railing length.

The kit of parts may include a plurality of railing lengths including the first railing length and the second railing length.

The first and second receiving means may be arranged such that a terminal end surface of the first railing length and a terminal end surface of the second railing length, when simultaneously received by the first receiving means and second receiving means respectively, face opposite sides of the partition means, and/or abut opposite sides of the partition means. Thus, the partition means may be used a “stop” against which a received end of a railing (e.g. handrail) length may be pushed or positioned thereby enabling the person assembling the railing to know when each received railing end is fully received and properly positioned. Measurements are not required to be taken to ensure correct positioning, and the assembler may be safe in the knowledge that the positioning/receipt of a subsequent railing (e.g. handrail) end is not influenced or affected by the position/presence of the railing (e.g. handrail) end already received by a given mounting means.

The first and second receiving means may be each structured and arranged such that when in simultaneous receipt of an end of a respective one of said first and second railing (e.g. handrail) lengths, the longitudinal axis of the first railing length is substantially collinear with the longitudinal axis of the second railing length. This enables a whole railing (e.g. handrail) assembly comprising several or many separate railing (e.g. handrail) lengths, when assembled, to appear linear and formed of one long and continuous railing length. The axis (e.g. longitudinal axis) of the first receiving means may be substantially collinear with that of the second receiving means. The first and second receiving means may be substantially identical in shape and structure.

A, or each, railing length may be any suitable elongate or pole-like structure arranged for use as a railing (e.g. handrail) length.

One or each of the first and second receiving means may include a sleeve or socket formation into which an end of one or each of the first and second railing (e.g. handrail) lengths is dimensioned to fit. The inner shape, surface and/or dimensions of one or both of the first and second receiving means may be structured to reciprocate the outer surface of an end of the railing length to be received thereby, so as to ensure a tight and intimate contact or fitting between the two in use. Preferably, the socket formation is such as to intimately circumferentially surround some or all a section of a railing (e.g. handrail) length terminating with the received end. The proportion/length of received section—i.e. the depth of the socket formation—may be that most suitable to the needs of the user. The deeper the socket, generally, the more secure and rigid will be the mounted railing length.

The kit of parts may include fixing means for fixing an end of one or both of the first and second railing (e.g. handrail) lengths to the mounting means. Nails or screws, or adhesives may be used. A spike or spikes may extend from one or both surfaces of the partition means faced by the two received railing length ends in use, being dimensioned to penetrate and/or grip a respective received railing length end. Spikes may be provided on the receiving surface of an/each receiving means to this end.

The fixing means may include one or more fixing apertures extending through the partition means and one or more fixing members (e.g. nails/screws). The fixing members may be shaped to enable only a part thereof to extend through a fixing aperture from the first receiving means to the second receiving means (e.g. the “head” of the fixing member being unable to pass through a fixing aperture), or vice versa, thereat to engage with a railing (e.g. handrail) length received by the second receiving means to fix the railing (e.g. handrail) length to the partition means.

The fixing means may include one or more fixing apertures extending through the first (and/or second) receiving means, and one or more fixing members shaped to extend through a fixing aperture from a surface of the first (or second) receiving means outwardly presented in use (preferably a surface downwardly presented in use, e.g. to avoid user's hands in a handrail assembly, and/or rainwater collection), and to engage with a railing (e.g. handrail) length received by the first (or second) receiving means to fix the railing length thereto.

A fixing member may be a screw, or a nail, dimensioned such that all but the head end thereof may pass through a fixing aperture. The kit of parts may comprise a plurality of mounting means, such as described above, to enable several/many lengths of railing (e.g. handrail) to be assembled into a whole railing assembly (e.g. handrail assembly) of any desired length.

In a second of its aspects, the present invention may provide a railing (e.g. handrail) assembly including a plurality of separate railing (e.g. handrail) lengths and a mounting means for simultaneously mounting an end of each of two railing (e.g. handrail) lengths to a common mounting location, the mounting means having a first receiving means in receipt of an end of a first of said two railing lengths, a second receiving means simultaneously in receipt of an end of a second of said two railing lengths, and a partition means positioned (e.g. fixed) between the first and second receiving means and arranged to prevent a railing length from engaging simultaneously parts of both the first receiving means and the second receiving means.

The first receiving means may be constructed and arranged to receive one end of the first railing length and the second receiving means may be structured and arranged to receive an end of a second railing length which is substantially identical in dimension, profile, shape or structure to an end (e.g. the other end) of the first railing length.

The first and second receiving means of the railing (e.g. handrail) assembly may be arranged such that a terminal end surface of said first railing length and a terminal end surface of said second railing length, simultaneously received by the first receiving means and second receiving means respectively, face opposite sides of the partition means, and/or abut opposite sides of the partition means.

The first and second receiving means of the assembly may each be structured and arranged such that the longitudinal axis of the first railing (e.g. handrail) length is substantially collinear with the longitudinal axis of the second railing (e.g. handrail) length. The axis (e.g. longitudinal axis) of the first receiving means may be substantially collinear with that of the second receiving means. The first and second receiving means may be substantially identical in shape and structure.

One or each of the first and second receiving means of the assembly may include a socket formation into which an end of one or each of the first and second railing (e.g. handrail) lengths is dimensioned to fit. The inner shape, surface and/or dimensions of one or both of the first and second receiving means may be structured to reciprocate the outer surface of an end of the railing length received thereby, so as to form a tight and intimate contact or fitting between the two. Preferably, the socket formation is such as to intimately circumferentially surround some or all a section of a railing (e.g. handrail) length terminating with the received end. The proportion/length of received section—i.e. the depth of the socket formation—may be that most suitable to the needs of the user. The deeper the socket, generally, the more secure and rigid will be the mounted railing length.

The railing assembly may include fixing means fixing an end of one or both of the first and second railing lengths to the mounting means.

The fixing means of the assembly may include one or more fixing apertures extending through the partition means and one or more fixing members each extending through a fixing aperture from the first receiving means to the second receiving means, whereat said part of the fixing member(s) engages with a railing length received by the second receiving means thereby fixing the railing length to the partition means.

The fixing means of the assembly may include one or more fixing apertures extending through the first receiving means, and one or more fixing members extending through a fixing aperture from an outwardly presented surface of the first receiving means, to engage with a railing (e.g. handrail) length received by the first receiving means thereby fixing the railing length thereto.

A fixing member of the assembly may be a screw, or a nail, dimensioned such that all but the head end thereof may pass through a fixing aperture. The railing (e.g. handrail) assembly may include a plurality of mounting means.

In a third of its aspects, the present invention may provide a railing (e.g. handrail) assembly assembled from a kit of parts according to the invention in its first aspect.

In a fourth aspect, the invention may provide a railing (e.g. handrail) comprising a mounted railing assembly according to the invention in its second or third aspects.

It is to be understood that the kit or parts, or assembly, described above realises a method of assembling a railing (e.g. handrail), as would be readily appreciated by the skilled person, and that method is encompassed by this invention and application.

The kit or parts, or assembly, according to any aspect of the invention, or as described above, may include one or more terminal mounting means arranged for mounting an end of only one railing (e.g. handrail) lengths to a mounting location, the terminal mounting means having a receiving means arranged to receive an end of a railing (e.g. handrail) length to terminate the railing assembly.

In a fifth of its aspects, the invention may provide a method of assembling a railing (e.g. handrail) assembly for simultaneously mounting an end of each of two railing (e.g. handrail) lengths to a common mounting location, the method including:
receiving upon the mounting means an end of a first of said two railing lengths; and,
receiving upon the mounting means an end of a second of said two railings lengths; and,
using a partition means fixed between the first and second receiving means to prevent a railing length from engaging simultaneously parts of both the first receiving means and the second receiving means.

The mounting means described above may be made and sold separately from (but for use with) the aforementioned plurality of railing lengths, or with only one railing length, as an extension pack or kit aimed at permitting single-length extension of a railing assembly (or kit therefor). The present invention encompasses such a mounting means, extension pack or kit. For example, the invention, in a sixth aspect, may provide a mounting means for a railing assembly, the assembly including a first railing length and a second railing length, wherein the mounting means is arranged for simultaneously mounting an end of the first railing length and an end of the second railing length to a common mounting location, the mounting means having a first receiving means arranged to receive an end of the first railing length, a second receiving means arranged simultaneously to receive an end of a second railing length, and a partition means positioned (e.g. fixed) between the first and second receiving means and arranged to prevent a railing length from engaging simultaneously parts of both the first receiving means and the second receiving means.

It is to be understood that the optional features of the mounting means, as described above in conjunction with railing lengths, are also optional features of the mounting means in isolation according to this sixth aspect.

The mounting means, according to any aspect of the invention, may include socket-shaped first and second receiving means being substantially circular in cross section, and may be of equal depth and general dimension.

Any or each railing length may define a channel (e.g. longitudinally aligned/directed) with a channel base surface at least part of which is shaped to project into the channel (e.g. convex base, such as circularly convex in cross section). A receiving means (e.g. socket), or each receiving means, may be arranged to receive (e.g. to connect to) the railing length via an abutment portion/surface thereof defining a recess shaped to receive the projecting base surface part such that parts of the abutment portion within the recess abut the received projecting base surface part when the railing length is connected to the receiving means in use. This enables greater lateral structural strength in the connection/interface between the receiving means, and mounting means, and the received rail length since the recessed abutment surface part restrains or prevents lateral motion of the projecting channel base received within it.

The recess may be shaped to reciprocate the shape of said projecting base surface part. The base surface of the channel may be generally convex, wherein the recess defined by the abutment portion presents a generally concave region shaped to reciprocate the shape of said generally convex base surface part and arranged for intimate abutment therewith in use.

The channel may define a pair of opposing channel walls and the abutment portion may be shaped to simultaneously abut, in use, opposing parts of the channel where the opposing channel walls meet the channel base. The abutment portion may defines a plurality of separate abutment surfaces within said recess, each separate abutment surface being arranged to abut the received projecting base surface part when a receiving means is connected to the railing length in use. The abutment portion may define a single continuous abutment surface within the recess arranged to abut the received projecting base surface part when the receiving means is connected to the railing length in use. The recess defined by the abutment portion is preferably presented outwardly of the receiving means. The abutment portion may form a sleeve shaped to receive a part of the railing length including the channel, the inner sleeve surface defining the recess.

The mounting means may include a stem portion extending from a surface of the mounting means (e.g. forming an underside in use), and terminating at a coupling part (e.g. a plate). The coupling part may possess, and present to a selected mounting surface/item upon which the railing assembly is to be mounted, an interface surface at which the mounting means and selected surface meet in use. Screw or nail holes may pass through the coupling plate from the surface thereof outwardly presented in use, to the interface surface, to permit screws or nails to be used to fix the coupling plate to the selected surface.

There now follow examples of the invention with reference to the drawings, of which:

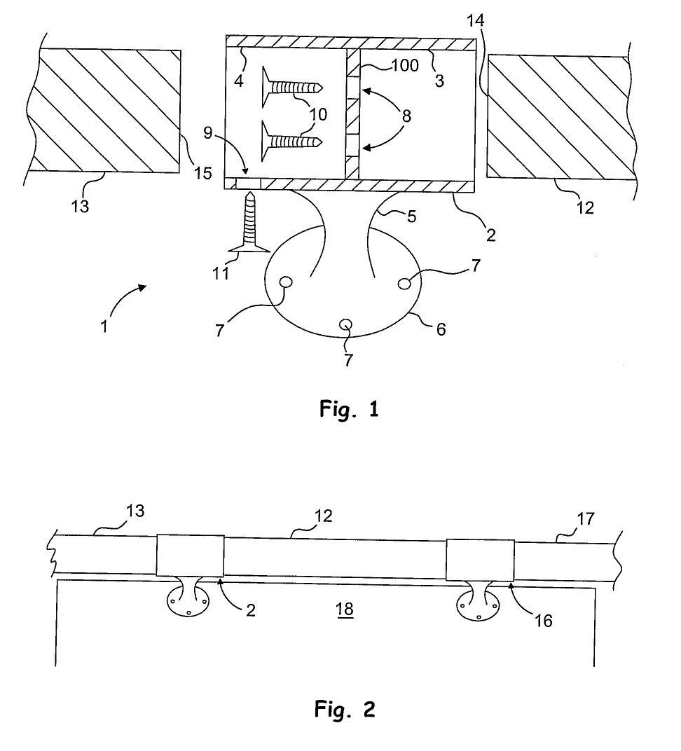

FIG. 1 represents, in longitudinal cross section, a kit of parts for a handrail assembly;

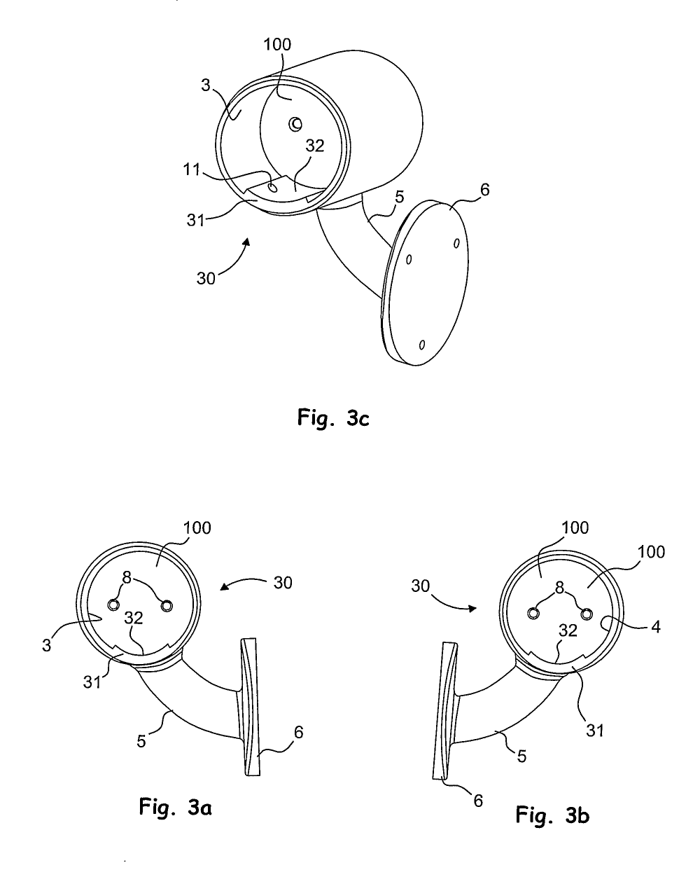

FIG. 2 represents a handrail assembly;

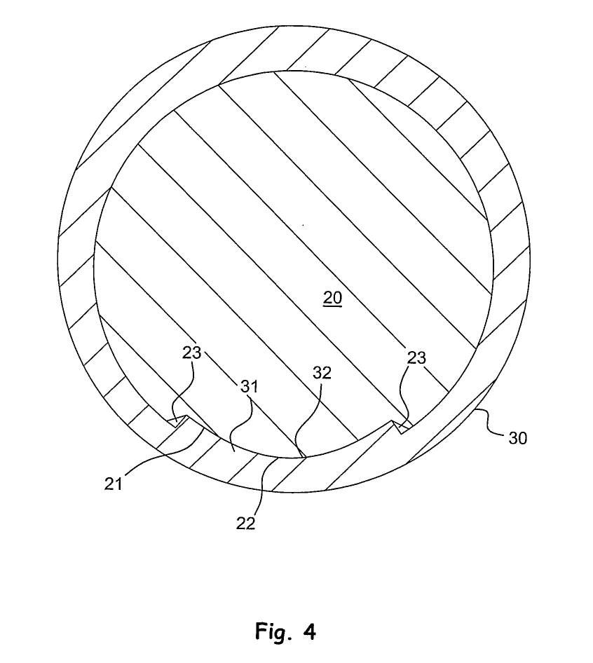

FIGS. 3a, 3b and 3c illustrate views of another example of a mounting means;

FIG. 4 illustrates a cross-sectional view of a handrail length used with the mounting means of FIGS. 3a, 3b and 3c.

In the figures like articles are assigned like reference symbols.

FIG. 1 illustrates a kit of parts 1 for a handrail assembly including a mounting part 2, and a first 12 and second 13 separate handrail lengths of circular cross section (end regions shown only). The mounting part includes a first circular socket formation 3 and a second circular socket formation 4 separated from the first circular socket formation by a partition 100.

The first circular socket 3, is shaped and dimensioned to intimately receive an end 14 of the first handrail length 12, while the second circular socket 4, is shaped and dimensioned to intimately receive an end 15 of the second handrail length 13. Consequently, the mounting part 2 is able to simultaneously receive the ends of both of the first and second handrail lengths simultaneously. The first and second circular sockets are arranged such that a terminal end surface 14 of the first handrail length and a terminal end surface 15 of the second handrail length, when simultaneously received by the first circular socket and second circular socket respectively, face opposite sides of (and abut) the partition 100. The first and second circular sockets are substantially identical to each other in shape and structure (though they need not be so), and share a common longitudinal axis. The result is that when in simultaneous receipt of an end of a respective one of said first and second handrail lengths, the longitudinal axis of the first handrail length is substantially collinear with the longitudinal axis of the second handrail length.

The mounting part includes two fixing apertures 8 extending through the partition 100 and two fixing screws 10 shaped to enable only a part thereof to extend through a fixing aperture from the second circular socket 4 to the first circular socket 3 (the head of each screw being dimensioned to prevent its passing through a fixing aperture). The fixing screws may engage with the terminal end 14 of the handrail length 12 received by the second circular socket to fix that handrail length to the partition.

A third fixing aperture 9 is formed in the underside of the mounting part adjacent the opening of the second circular socket, and extending into the latter. A third fixing screw 11 is provided to extend through the third fixing aperture (but not the screw head) and to engage with, and fix in position, the end region of the second handrail length 13 when received by the second circular socket 4. The fixing screws are optional in this example, or course, as the positioning of a mounting part at each end of a given length of handrail prevents that length, when mounted, from separating from the mounting parts—the ends being constrained within their respective circular sockets.

The mounting means has a stem portion 5 extending from a surface of the mounting means forming an underside in use, and terminating at a coupling plate 6 which presents to the selected surface (item 18 of FIG. 2) upon which the handrail assembly is to be mounted an interface surface (reverse side of item 6, not shown) at which the mounting part and selected surface meet in use. Screw or nail holes 7 pass through the coupling plate from the surface thereof outwardly presented in use, to the interface surface, and permit screws or nails (not shown) to be used to fix the coupling plate to the selected surface.

The assembled handrail may be mounted upon a desired surface 18 (e.g. a wall) once assembled or during assembly. Any overall length of handrail may be assembled in this way using a suitable number of mounting parts and handrail lengths. The kit or parts, or assembly, as described above, may include one or more terminal mounting parts (not shown) arranged for mounting an end of only one handrail length (a terminal one) to a mounting location (e.g. 18), the terminal mounting part having a receiving socket arranged to receive an end of a handrail length to terminate the handrail assembly.

FIG. 4 illustrates, in cross section, a handrail length 20 used with the mounting means 30 of FIGS. 3a, 3b and 3c. The handrail length defines a channel 21 extending longitudinally along the handrail length at the underside thereof in use. The channel has a channel base surface 22 at least part of which is circularly convex in shape (in cross section) to project into the channel. Referring to FIGS. 3a, 3b and 3c, the mounting means 30 is arranged for use with the handrail length of FIG. 4, and has identical first and second socket-shaped receiving means (3, 4) arranged to receive and connect to a handrail length 20 via (among other parts) an abutment portion/surface 31 thereof defining a recess 32 shaped to receive the projecting base surface part 22 of the handrail length such that parts of the abutment portion 31 within the recess abut the received projecting base surface 22 part when the handrail length is connected to the receiving means in use as shown in FIG. 4.

The recess 32 is concavely shaped to reciprocate the shape of said projecting base surface part 22 for intimate abutment therewith in use. The channel 21 defines a pair of opposing channel walls 23 and the abutment portion 31 is shaped to simultaneously abut, in use, opposing parts of the channel where the opposing channel walls meet the channel base. The abutment portion defines a single continuous abutment surface within the recess arranged to abut the received projecting base surface part when the receiving means is connected to the railing length in use. The recess defined by the abutment portion is presented outwardly of the receiving means, and the abutment portion forms a socket/sleeve (3, 4) shaped to intimately receive the end part of the handrail length including the channel, with the inner sleeve surface defining the recess. The convex/concave interface between the channel base and reciprocal abutment surface ensure greater lateral rigidity or strength in the connection between the receiving means and a received handrail length.

It is to be understood that the above-described examples are not limiting, and that modifications and variants thereof such as would be readily apparent to the skilled person, are encompassed by this invention.

1-38. (canceled)

39. A kit of parts for a railing assembly including a first railing length which defines a channel with a channel base surface at least part of which is shaped to project into the channel and a mounting means for simultaneously mounting an end of the first railing length and an end of a second railing length to a common mounting location, the mounting means having a first receiving means arranged to receive an end of the first railing length via an abutment portion thereof defining a recess shaped to receive the projecting base surface part such that parts of the abutment portion are permitted to abut to a said received projecting base surface part, a second receiving means arranged simultaneously to receive an end of a second railing length, and a partition means positioned between the first and second receiving means and arranged to prevent a railing length from engaging simultaneously parts of both the first receiving means and the second receiving means.

40. A kit of parts according to claim 39 wherein the recess is shaped to reciprocate the shape of said projecting base surface part.

41. A kit of parts according to claim 39 wherein the base surface of the channel is generally convex and the recess defined by the abutment portion presents a generally concave region shaped to reciprocate the shape of said generally convex base surface part and arranged for intimate abutment therewith in use.

42. A kit of parts according to claim 39 in which the channel defines a pair of channel walls and the abutment portion is shaped to simultaneously abut, in use, opposite parts of the channel where the channel walls meet the channel base.

43. A kit of parts according to claim 39 in which the abutment portion defines a plurality of separate abutment surfaces within said recess, each separate abutment surface being arranged to abut the received projecting base surface part when a receiving means is connected to the railing length in use.

44. A kit of parts according to any claim 39 including fixing means for fixing an end of one or both of the first and second railing lengths to the mounting means.

45. A kit of parts according to claim 44 in which the fixing means includes one or more fixing apertures extending through the partition means and one or more fixing members shaped to enable only a part thereof to extend through a fixing aperture from the first receiving means to the second receiving means, thereat to engage with a railing length received by the second receiving means to fix the railing length to the partition means.

46. A kit of parts according to claim 44 in which the fixing means includes one or more fixing apertures extending through the first receiving means, and one or more fixing members shaped to extend through a fixing aperture from a surface of the first receiving means outwardly presented in use, and to engage with a railing length received by the first receiving means to fix the railing length thereto.

47. A railing assembly assembled from a kit of parts according to any of claims 39 to 46.

48. A railing assembly including a plurality of separate railing lengths a first of which defines a channel with a channel base surface at least part of which is shaped to project into the channel, and a mounting means simultaneously mounting an end of each of two railing lengths to a common mounting location, the mounting means having a first receiving means in receipt of an end of said first of said two railing lengths via an abutment portion thereof defining a recess shaped to receive the projecting base surface part wherein parts of the abutment portion abut to a said received projecting base surface part, a second receiving means simultaneously in receipt of an end of a second of said two railing lengths, and a partition means positioned between the first and second receiving means and arranged to prevent a railing length from engaging simultaneously parts of both the first receiving means and the second receiving means.

49. A method of assembling a railing assembly for simultaneously mounting an end of each of two railing lengths to a common mounting location, a first of the two railing lengths defining a channel with a channel base surface at least part of which is shaped to project into the channel, the method including:
receiving at a first receiving means of the mounting means an end of said first of said two railing lengths via an abutment portion of the first receiving means which defines a recess shaped to receive the projecting base surface part wherein parts of the abutment portion abut to a said received projecting base surface part; and,
receiving upon the mounting means an end of a second of said two railing lengths; and,
using a partition means fixed between the first and second receiving means to prevent a railing length from engaging simultaneously parts of both the first receiving means and the second receiving means.

50. A mounting means for a railing assembly, the assembly including a first railing length which defines a channel with a channel base surface at least part of which is shaped to project into the channel and a second railing length, wherein the mounting means is arranged for simultaneously mounting an end of the first railing length and an end of the second railing length to a common mounting location, the mounting means having a first receiving means arranged to receive an end of the first railing length via an abutment portion thereof defining a recess shaped to receive the projecting base surface part such that parts of the abutment portion are permitted to abut to a said received projecting base surface part, a second receiving means arranged simultaneously to receive an end of a second railing length, and a partition means positioned between the first and second receiving means and arranged to prevent a railing length from engaging simultaneously parts of both the first receiving means and the second receiving means.

51. A mounting means according to claim 50 in which the abutment portion defines a plurality of separate abutment surfaces within said recess, each separate abutment surface being arranged to abut the received projecting base surface part when a receiving means is connected to the railing length in use.

52. A mounting means according to claim 50 including fixing means fixing an end of one or both of the first and second railing lengths to the mounting means.

53. A mounting means according to claim 52 in which the fixing means includes one or more fixing apertures extending through the partition means and one or more fixing members each arrangeable to extend through a fixing aperture from the first receiving means to the second receiving means, whereat said part of the fixing member(s) may engage with a railing length received by the second receiving means thereby fixing the railing length to the partition means.

54. A mounting means according to claim 52 in which the fixing means includes one or more fixing apertures extending through the first receiving means, and one or more fixing members arrangeable to extend through a fixing aperture from an outwardly presented surface of the first receiving means, so as to engage with a railing length received by the first receiving means thereby fixing the railing length thereto.
